(19) United States
(12) Patent Application Publication
(10) Pub. No.: US 2002/0074367 A1
(43) Pub. Date: Jun. 20, 2002

(54) Gravity-fed liquid chemical dispenser bottle

(76) Inventor: Kevin Kawakita, Temple City, CA (US)

Correspondence Address: KEVIN KAWAKITA, 5812 TEMPLE CITY BL. #100, TEMPLE CITY, CA, 91780, US

(21) Appl. No.: 09/837,314

(22) Filed: Apr. 19, 2001

Related U.S. Application Data
(60) Provisional application No. 60/256,103, filed on Dec. 18, 2000.

(51) Int. Cl. B67D 3/00; B67D 5/06

(52) U.S. Cl. 222/517; 222/534

(57) ABSTRACT

Drawing FIG. 3 shows a Gravity-fed Liquid Chemical Dispenser Bottle (100), which stops the irritating wait for a bottle turned upside down to dispense thick Liquid Chemical (204) such as condiments, pharmaceuticals, motor oil, etc. especially with a low bottle, furthermore, the gravity-fed device stops the need to flip the bottle over to dispense such as in prior art ketchup bottles or motor oil bottles which can create a messy spill, furthermore, said gravity-fed device also stops the undesirable dispensing of Non-emulsified Liquid from Liquid Chemical (202) which floats to the top of a prior art bottle and is dispensed first along with air (202), furthermore, this invention stops the waste of Liquid Chemical (204) near the bottom and on the sides of prior art bottles which is now often thrown away, furthermore, the device is useful for, but, not limited to thicker, slow Liquid Chemicals (204) such as ketchup, mustard, barbecue sauce, relish, mayonnaise, etc, pharmaceuticals such as hand lotions, creams, shampoos, etc., and automobile chemicals such as anti-freeze, hydraulic fluid, motor oil, etc., furthermore, the device consists of a glass or squeezable plastic bottle shaped like a prior art ketchup bottle having a Twist Ventilation Only Cap (102) on top of the bottle, a One-way Trapdoor Diaphragm (103) to prevent spills and Liquid Chemical (204) dispensing from the top, a Real Bottle Top with Ventilation Hole (104), a Liquid Chemical Bottle Body (106), a Real Bottle Bottom ts with Nozzle (108), a Flip-off/Flip-on Nozzle Cap (110), and a False Bottle Bottom or Stand (112), furthermore, the Twist Ventilation Only Cap (102) is optionally rotatable to allow air (202) intake through the Real Bottle Top with Ventilation Hole (104) with means to prevent a vacuum developing on large dispenses, furthermore, the False Bottle Bottom or Stand (112) is detachable by a screwing, flipping, or snapping motion revealing the Real Bottle Bottom with Nozzle (108).

### BACKGROUND

1. Field of Invention

This invention relates to food container packaging and dispenser bottles in particular to condiment dispenser bottles (e.g. ketchup bottles, thick salad dressing bottles, mustard bottles, relish bottles, mayonnaise bottles, etc.).

This invention also relates to pharmaceutical and cosmetic packaging and dispenser bottles (e.g. hand and body lotion bottles, shampoo bottles, liquid soap bottles, perfume bottles, etc.).

This invention also relates to automobile chemical packaging and dispenser bottles (e.g. motor oil bottles, anti-freeze bottles, hydraulic fluid bottles, transmission fluid bottles, anti-freeze bottles, fuel-injection cleaner bottles, gas and oil treatment bottles, etc.).

This invention also relates to household chemical packaging and dispenser bottles (e.g. glass cleaner spray bottles, tile cleaner spray bottles, etc.).

PATENT CLASS: Utility Patent in the Machine class.

PATENT SUBCLASS:

Disposable Liquid Chemical Packaging and Dispensing Devices

Disposable Food Packaging Devices.

Disposable Cosmetic and Pharmaceutical Packaging Devices.

Disposable Auto Chemical Devices.

Disposable Household Chemical Packaging Devices.

2. Discussion of Prior Art

Public Domain Usage

Public domain usage of prior art household sized, food container and dispensing bottles are glass bottles, plastic bottles, squeezable plastic bottles (upright) which dispense from a top nozzle or opening.

There are also prior art uses of disposable, squeezable plastic and aluminum, individual serving container size, condiment dispensers for take-out restaurants.

There are prior art, patented uses of gravity-fed, industrial size dispenser packaging and holder dispensers for use in fast food restaurants and convenience stores which use industrial size, large 3-5 gallon size, upside down, replaceable “service packs” to dispense soft drinks, condiments, hot chili, melted cheddar cheese topping, etc.

No current manufacturer of food containers currently has an effective solution for a household sized, personal-use sized, gravity-fed, condiment packaging and dispenser bottle with bottom dispensing in public domain usage, patent pending, or patented usage.

Pharmaceutical containers and dispensers as for shampoos exist in prior art as squeezable plastic bottles made of PolyEthylene (PE) or High Density PolyEthylene (HDPE) plastic with a top nozzle and removable cap.

Auto chemical containers and dispensers for motor oil and anti-freeze use High Density PolyEthylene plastic (HDPE) with a plastic, screw-on, top cap.

Household chemicals use plastic bottles with index finger, push-spray tops, pour or squirt spouts. High Density PolyEthylene plastic (HDPE) is popular for low cost and recycling. Glass is used for long lasting, more expensive dispensing and is prized for its non-reactance or inert properties. Aerosol cans are used only where necessary and an environmentally sound propellant is used.

The U.S. patent Literature prior art has several patents for gravity-fed, liquid chemical, dispenser bottles. None of these has been put into widespread, commercial use due to several basic design flaws.

U.S. Pat. No. 6,161,737

Date of Issue: Dec. 19, 2000

Filing Date: Feb. 2, 1999

Issued to: Leary, Cornelius F.

This patent covers a bottom dispensing, household sized, rectangular shaped, liquid chemical packaging dispenser with a built-in handle on top and a flip-down, side-mounted nozzle. The flip-down motion opens and closes the nozzle.

This patent does not have a dedicated, top mounted ventilation hole protected by a one-way diaphragm which allows air down, but, does not allow liquid to move up. My patent includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allow air to come back up through the single bottom spout in a “hiccup” action with non-viscous liquids and failed operation with viscous liquids causing the user to turn the bottle right-side up which clears viscous liquid out of the bottom nozzle. The Leary patent has no means whatsoever for top ventilation while dispensing from the bottom nozzle.

This Leary patent also does not have a drip catching removable bottom piece, so, liquid drips will fall on a table or floor.

This Leary patent mentions no recessed bottom with a built-in, stand to cover the bottom-nozzle and bottom-cap.

U.S. Pat No. 5,482,172

Date of Issue: Jan. 9, 1996

Filing Date: Sep. 16, 1993

Issued to: Braddock, Calvin C.

This patent covers a symmetric, either top dispensing, or bottom dispensing, rectangular shaped, household sized, liquid chemical packaging dispenser with a flip-cap exposed, top nozzle and a flip-cap exposed, bottom nozzle. The liquid chemical held inside the rectangular shaped, dispenser can flow to either nozzle as there is no preferred top or bottom side.

This patent does not have a dedicated, top mounted ventilation hole protected by a one-way diaphragm which allows air down, but, does not allow liquid to move up. My patent includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Braddock patent will allow use of the current top nozzle as an air intake nozzle even when it is not designed or specified for this purpose while the liquid dispensing occurs on the current bottom nozzle. The drawback of this Braddock design is that viscous and air hardened, liquid chemical will in all probability clog the current top nozzle blocking the air intake of a duo-use nozzle.

This Braddock patent also does not have a drip catching removable bottom piece, so, liquid drips will fall on a table or floor.

This Braddock patent mentions no recessed bottom with a built-in, stand to cover the bottom-nozzle and bottom-cap.

U.S. Pat. No. 5,421,488

Date of Issue: Jun. 6, 1995

Filing Date: Jun. 17, 1994

Issued to: Ehrbar, James J.

This patent covers a symmetric, either top dispensing, or bottom dispensing, cylindrical shaped, household sized, liquid chemical packaging dispenser with a flip-cap exposed, top nozzle and a flip-cap exposed, bottom nozzle. The liquid chemical cavity inside the cylindrical shaped, dispenser can flow to either nozzle as there is no preferred top or bottom side.

This patent does not have a dedicated, top mounted ventilation hole protected by a one-way diaphragm which allows air down, but, does not allow liquid to move up. My patent includes such a valve. This top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Ehrbar patent will allow use of the current top nozzle as an air intake nozzle even when it is not designed or specified for this purpose while the liquid dispensing occurs on the current bottom nozzle. The drawback of this Ehrbar, design is that viscous and air hardened, liquid chemical will in all probability clog the current top nozzle blocking the air intake of a duo-use nozzle.

This Ehrbar patent also does not have a drip catching removable bottom piece, so, liquid drips will fall on a table or floor.

This Ehrbar patent mentions no recessed bottom with a built-in, stand to cover the bottom-nozzle and bottom-cap.

U.S. Pat. No. 5,141,136

Date of Issue: Aug. 25, 1992

Filing Date: Jan. 25, 1991

Issued to: Tignor, Jeffrey H.

This patent covers a house-hold, viscous liquid dispensing, plastic bottle with an open top having a removable cap and a sealed bottom with a nozzle and removable cap which bottom-nozzle and bottom-cap are contained within a recessed formation which also serves as a built-in, bottle stand. The liquid chemical held inside the bottle shaped, dispenser can flow to either top or bottom nozzle with top dispensing used most of the time and bottom dispensing used when the bottle is low with liquid chemical.

This patent does not have a dedicated, top mounted ventilation hole protected by a one-way diaphragm which allows air down, but, does not allow liquid to move up. My patent includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Tignor patent will allow use of the dual-use, removable, top cap as an air intake even when it is not designed or specified for this purpose while the liquid dispensing occurs on the single-use, bottom nozzle. Viscous and air hardened, liquid chemical will in all probability not clog or partially clog the Tignor design by blocking or reducing the air intake of a duo-use top cap if it is large enough. As specified in the design and legal claims of the Tignor patent, the top opening is covered by a removable cap. A removable cap is not the best choice for an air nozzle as the cap must be stored somewhere and re-fastened after use.

This Tignor patent also does not have a drip catching removable bottom piece, so, liquid drips will fall on a table or floor.

This Tignor patent mentions a recessed bottom with a built-in, stand to cover the bottom-nozzle and bottom-cap.

U.S. Pat. No. 5,033,655

Date of Issue: Jul. 23, 1991

Filing Date: Apr. 25, 1989

Issued to: Brown, Paul E.

This patent covers a house-hold, viscous liquid dispensing, squeezable, plastic bottle with a top having a small opening which is capped with a hand-activated, top-cap, a sealed bottom with a bottom-nozzle covered by various embodiments of pressure activated, self-sealing, self-opening and self-closing, bottom-caps which bottom-nozzle and bottom-cap is optionally contained within a recessed formation which also serves as a built-in, bottle stand. The dispenser works with either top or bottom dispensing of liquid chemical. The liquid chemical held inside the bottle shaped, dispenser flows by gravity to dispense from the top opening if the top cap is manually removed with a flipped over bottle. Alternatively, the liquid chemical is pressure forced out of the pressure activated bottom-nozzle. An optional snap-on, drip catching, bottom-cap safety cover is mentioned.

The top opening has no stated design or legal claims mention of duo-use for liquid dispensing with a flipped over bottle with the top cap manually removed or air intake from the top opening with the bottle used in right-side up for bottom dispensing. In fact duo-use of the top cap for air intake in this design is physically impossible. If the top opening without a cap is used for air intake for right-side up, bottom dispensing, hand-squeezing pressure on the deformable sides of the bottle will not produce enough pressure to activate the pressure activated, self-sealing, bottom-nozzle. In bottom-feed operation, the top opening must be closed by manual sealing with the top cap to allow side pressure build-up to activate the pressure activated, self-sealing, bottom-nozzle.

This patent does not have a dedicated, top mounted ventilation hole protected by a one-way diaphragm which allows air down, but, does not allow liquid to move up. My patent includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allow air to come back up through the single bottom spout in a “hiccup” action with non-viscous liquids and failed operation with viscous liquids causing the user to turn the bottle right-side up which clears viscous liquid out of the bottom-nozzle.

This Brown patent will physically not allow dual-use of the top opening as an air intake opening or top dispensing opening. As mentioned in the design and legal claims of the Brown patent, the bottom nozzle must be of a pressure activated, self-sealing, self-opening and self-closing, design of various embodiments. My patent does not have this design or legal claim. Furthermore, the Brown design will not work efficiently in continuous dispensing of non-viscous fluids and with one “squeeze” action with viscous liquids due to the absence of any form of top mounted ventilation hole.

This Brown patent also describes optional use of a separate drip catching removable bottom piece, so, liquid drips will not fall on a table or floor.

This Brown patent mentions an optional recessed bottom with a built-in, stand to cover the bottom-nozzle and bottom-cap.

U.S. Pat. No. 4,762,241

Date of Issue: Aug. 9, 1988

Filing Date: Feb. 5, 1987

Issued to: Lang, Richard R.

This patent covers a house-hold, viscous liquid dispensing, bottle with an top with a small opening having a removable cap and a sealed bottom with a nozzle and removable cap which bottle's bottom may be optionally sloped towards the rim-mounted bottom-nozzle and bottom-cap.

The liquid chemical held inside the bottle shaped, dispenser can flow to either top opening or bottom nozzle. Top dispensing is used most of the time with bottom dispensing used when the bottle is low with liquid chemical.

This patent does not have a dedicated, top mounted ventilation hole protected by a one-way diaphragm which allows air down, but, does not allow liquid to move up. My patent includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Lang patent will allow use of the dual-use, top nozzle as an air intake opening even when it is not designed or specified for this purpose while the liquid dispensing occurs on the single-use, bottom nozzle. The drawback of this Lang design is that viscous and air hardened, liquid chemical will in all probability clog or partially clog the current top opening blocking or reducing the air intake of a duo-use nozzle. If the top opening is made large it will reduce such air blockage problems. As specified in the design and legal claims of the Lang patent, the top opening is covered by a removable cap. A removable cap is not the best choice for an air opening as the cap must be stored somewhere and re-fastened after use.

This Lang patent also does not have a drip catching removable bottom piece, so, liquid drips will fall on a table or floor.

This Lang patent describes a recessed bottom with a built-in, stand to cover the bottom-nozzle and bottom-cap.

U.S. Pat. No. 4,428,507

Date of Issue: Jan. 31, 1984

Filing Date: Jun. 21, 1982

Issued to: Sneider, Vincent R.

This patent covers a house-hold, viscous liquid dispensing, bottle with a cylindrical shape, accordion side-walls, closed top having a push-in, pull-out nozzle, and a sealed bottom with a nozzle and twist-open, twist-close spigot.

The liquid chemical held inside the cylindrical shaped, dispenser can flow to either top or bottom nozzle with top dispensing used most of the time and bottom dispensing used when the bottle is low with liquid chemical.

This patent does not have a dedicated, top mounted ventilation hole protected by a one-way diaphragm which allows air down, but, does not allow liquid to move up. My patent includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Sneider patent will allow use of the dual-use, top nozzle as an air intake nozzle even when it is not designed or specified for this purpose while the liquid dispensing occurs on the single-use, bottom nozzle. The drawback of this Sneider design is that viscous and air hardened, liquid chemical will in all probability clog or partially clog the current top nozzle blocking or reducing the air intake of a duo-use nozzle. If the top nozzle is made large it will reduce such air blockage problems.

This Sneider patent also does not have a drip catching removable bottom piece, so, liquid drips will fall on a table or floor.

This Sneider patent describes a recessed bottom with a built-in, stand to cover the bottom-nozzle and bottom-cap.

U.S. Pat. No. 2,779,472

Date of Issue: Jan. 29, 1957

Filing Date: Apr. 6, 1953

Issued to: Febbraro, Mario

This patent covers a house-hold, liquid dispensing, bottle with an open top having a removable cap and a sealed bottom with a nozzle and removable cap which bottle's bottom has a built-in sediment trap for filtering liquids such as wine.

The liquid chemical held inside the bottle shaped, dispenser can flow to either top or bottom nozzle with top dispensing used most of the time and bottom dispensing used when the bottle is low with liquid chemical.

This patent does not have a dedicated, top mounted ventilation hole protected by a one-way diaphragm which allows air down, but, does not allow liquid to move up. My patent includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Febbraro patent will allow use of the dual-use, top opening as an air intake opening even when it is not designed or specified for this purpose while the liquid dispensing occurs on the single-use, bottom nozzle. The drawback of this Febbraro design is that viscous and air hardened, liquid chemical will in all probability clog or partially clog the current top opening blocking or reducing the air intake of a duo-use opening. If the top opening is made large it will reduce such air blockage problems. As specified in the design and legal claims of the Febbraro patent, the top opening is covered by a removable cap. A removable cap is not the best choice for an air nozzle as the cap must be stored somewhere and re-fastened after use.

This Febbraro patent also does not have a drip catching removable bottom piece, so, liquid drips will fall on a table or floor.

This Febbraro patent describes a recessed bottom with a built-in, stand to cover the bottom-nozzle and bottom-cap.

U.S. Pat. No. 1,660,606

Date of Issue: Feb. 28, 1928

Filing Date: Apr. 19, 1926

Issued to: Evans, Hopkins

This patent covers a house-hold, liquid dispensing, bottle shaped like a glass, milk-bottle, with an open top having a removable cap and a screw-on, sealed bottom without the use of any opening or nozzle. This bottle is intended for top dispensing only. The screw-on, sealed bottom is merely used in factory maintenance at the bottling plant to allow easier either end and through the ends cleaning and scrubbing of used bottles such as re-usable glass milk and glass cola bottles.

This patent does not have a dedicated, top mounted ventilation hole protected by a one-way diaphragm which allows air down, but, does not allow liquid to move up. My patent includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Evans patent also does not have a drip catching removable bottom piece, as, bottom dispensing is not allowed.

U.S. Design Pat. No. 315,096

Date of Issue: Mar. 5, 1991

Filing Date: Jan. 12, 1987

Issued to: Rocchio, Chris A.

This design patent covers a house-hold, liquid dispensing, bottle with an open top having a removable cap and a sealed bottom with a nozzle and removable cap.

The liquid chemical held inside the bottle shaped, dispenser can flow to either top or bottom nozzle with top dispensing used most of the time and bottom dispensing used when the bottle is low with liquid chemical.

This patent does not have a dedicated, top mounted ventilation hole protected by a one-way diaphragm which allows air down, but, does not allow liquid to move up. My patent includes such a valve. This dedicated, top mounted ventilation hole is necessary for proper efficient dispensing in order to avoid production of a vacuum inside the container with continuous dispensing actions. Otherwise, air must enter from the bottom spout after one, dispensing, liquid squeeze uses up the available air in the closed container. Interrupted dispensing actions allows air to come back up through the single bottom spout in a “hiccup” action with non-viscous liquids and failed operation with viscous liquids causing the user to turn the bottle right-side up which clears viscous liquid out of the bottom-nozzle.

This Rocchio patent will allow use of the dual-use, top opening as an air intake opening even when it is not designed or specified for this purpose while the liquid dispensing occurs on the single-use, bottom nozzle. The drawback of this Rocchio design is that viscous and air hardened, liquid chemical will in all probability clog or partially clog the current top opening blocking or reducing the air intake of a duo-use nozzle. If the top opening is made large it will reduce such air blockage problems.

This Rocchio patent also does not have a drip catching removable bottom piece, so, liquid drips will fall on a table or floor.

This Rocchio patent describes a recessed bottom with a built-in, stand to cover the bottom-nozzle and bottom-cap.

### SUMMARY

Paraphrase of Main Claim

A personal size, bottle device (100) for dispensing Liquid Chemicals (204) with means for dispensing of the Liquid Chemicals (204) utilizing gravity-fed operation through the dedicated to liquid and not Air (200) Real Bottle Bottom with Nozzle (108) with a dedicated to air and not liquid, Twist Ventilation Only Cap (102), Real Bottle Top with Ventilation Hole (104) used for air (200) intake through a One-way Trap Door Diaphragm (103).

### OBJECTS & ADVANTAGES

Over Prior Art

A. An object of this invention is to prevent the nagging wait for a prior art bottle turned upside-down to drain especially from a low bottle with thick Liquid Chemicals (204).

B. An object of this invention is to prevent the dispensing of air (200) and Non-emulsified Liquid from Liquid Chemical (202) which floats to the top of a prior art bottle.

C. An object of this invention is to stop the waste of Liquid Chemical (204) at the bottom of prior art bottles which is now often thrown away.

D. An object of this invention is to stop the waste of Liquid Chemical (204) at the sides of prior art bottles which clings there after the bottle is turned upside down and increases in amount when the bottle is near empty.

E. An object of this invention is to not require the need to flip the bottle (100) upside down to dispense Liquid Chemical (204) such as in motor oil which creates messy spills when the target is missed and wastes effort.

F. An object of this invention is to be inexpensive and convenient to use in comparison to prior art bottles.

G. An object of this invention is that it can be made with current manufacturing technologies for glass and plastic.

H. An object of this invention is that it uses a dedicated Twist Ventilation Only Cap (102), and Real Bottle Top with Ventilation Hole (104) for Air (200) ventilation and a dedicated, Real Bottle Bottom with Nozzle (108) for bottom only dispensing of the Liquid Chemical (204).

I. An object of this invention is that it uses a special One-way Trap Door Diaphragm (103) type of diaphragm at the top of the bottle (100) to stop accidental Liquid Chemical (204) spills from the Real Bottle Top with Ventilation Hole (104) and Twist Ventilation Only Cap (102).

J. An object of this invention is to supply an embodiment which is a very low cost, disposable bottle for one-time dispensing of things such as motor oil, anti-freeze, fuel-injector cleaner, oil treatments, gasoline treatments, brake fluid, transmission fluids, etc.

K. An object of this invention when used in an embodiment of an upside-down, upwards thumb-depressed or sideways hand-squeezed, operated spray bottle (100). An object of this embodiment with hand-spray bottles (100) is to stop the frustrating “air intake” (200) strokes which occur when a half-empty prior art, top spray, bottle is used tipped to the side. In a prior art, top spray bottle with a suction tube, frustrating “air intake” (200) strokes occur and Liquid Chemical (204) is wasted with half empty bottles used tipped to the side creating air (200) pockets around the base of the suction tube.

Z. Further objects and advantages of my invention will become apparent from a consideration of the drawings and ensuing description of it.

### BRIEF DESCRIPTION OF DRAWINGS

All Embodiments

FIG. 1 is a perspective drawing of the invention, a Gravity-fed Liquid Chemical Dispenser Bottle (100), as it would appear standing on a Kitchen Table (208).

FIG. 2 is a close-up view of the actions of optionally twisting the Twist Ventilation Only Cap (102), and removing the False Bottle Bottom or Stand (112) to expose the Real Bottle Bottom with Nozzle (108). The Flip-off/Flip-on Nozzle Cap (110) on Real Nozzle Bottom with Nozzle (108) is shown in a closed position.

FIG. 3 is a close-up view of the action of dispensing Liquid Chemical (204) through the Real Bottle Bottom with Nozzle (108) after removal of the False Bottle Bottom or Stand (112) and opening the Flip-off/Flip-on Nozzle Cap (110) on Real Nozzle Bottom with Nozzle (108). A Hamburger (206) is shown to receive the Liquid Chemical (204) which in this case is ketchup.

FIG. 4 is a close-up view of the action of closing the Flip-off/Flip-on Nozzle Cap (110) on Real Bottle Bottom with Nozzle (108), and placing the Liquid Chemical Bottle Body (106) back upon the False Bottle Bottom or Stand (112). The Twist Ventilation Only Cap (102) is lastly twisted shut.

FIG. 5 is a standing view of an alternative embodiment, very low cost, Gravity-fed Liquid Chemical Dispenser Bottle (100) meant for disposable, 1-time dispensing use which uses a very low cost, 5-piece design.

FIG. 6 is a standing view of an alternative embodiment, Gravity-Fed Liquid Chemical Dispenser Bottle (100) meant for a bottom dispensing, spray bottle with a Hand-Squeeze Pump Piston (158) mechanism.

List of Reference Numerals—All Embodiments

100. Gravity-fed Liquid Chemical Dispenser Bottle

102. Twist Ventilation Only Cap

103. One-way Trap Door Diaphragm

104. Real Bottle Top with Ventilation Hole

106. Liquid Chemical Bottle Body

108. Real Bottle Bottom with Nozzle

110. Flip-off/Flip-on Nozzle Cap

112. False Bottle Bottom or Stand

On 1st Alternative Embodiment Only

150. Top Self-Adhesive Seal

152. Twist-open Nozzle Cap

154. Bottom Self-Adhesive Seal

On 2nd Alternative Embodiment Only

156. Twist Open and Close Drip Deactivator

158. Hand-Squeeze Pump Piston

160. Adjustable Spray Pattern Nozzle

Following Parts are not part of Invention

200. Air

202. Non-emulsified Liquid from Liquid Chemical

204. Liquid Chemical

206. Hamburger

208. Kitchen Table

### DESCRIPTION OF INVENTION

### Detailed Description of Drawings

Preferred Embodiment

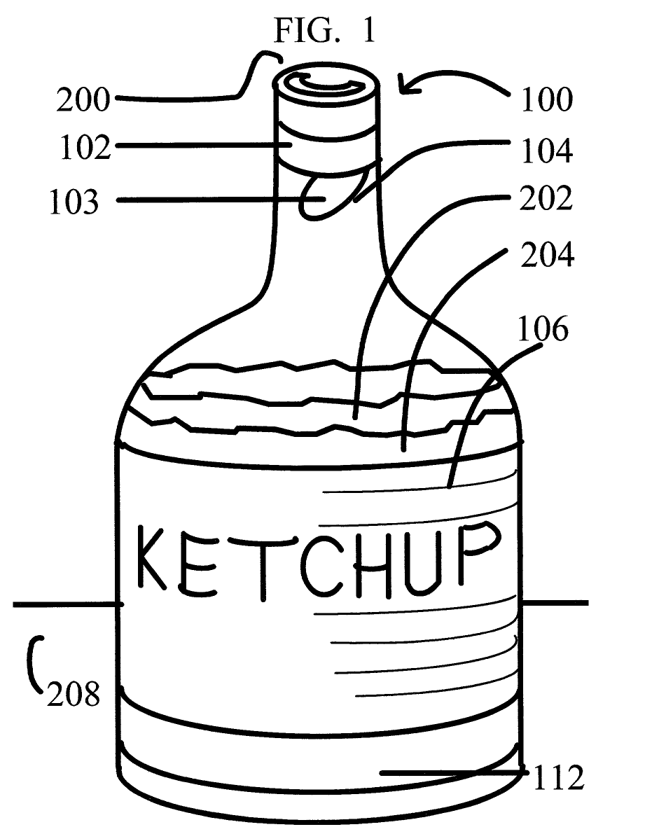

FIG. 1 is a perspective drawing of the invention, a Gravity-fed Liquid Chemical Dispenser Bottle (100), as it would appear standing on a Kitchen Table (208).

The Twist Ventilation Only Cap (102) is shown, the One-way Trap Door Diaphragm (103) is shown, the Real Bottle Top with Ventilation Hole (104) is shown, the Liquid Chemical Bottle Body (106) is shown, the Real Bottle Bottom with Nozzle (108) is shown, and the False Bottle Bottom or Stand (112) is shown. The Non-Emulsified Liquid from Liquid Chemical (202) is shown settling to the top of the Liquid Chemical (204). The Liquid Chemical (204) is shown. The Gravity-fed Liquid Chemical Dispenser Bottle (100) may be optionally shaken before use.

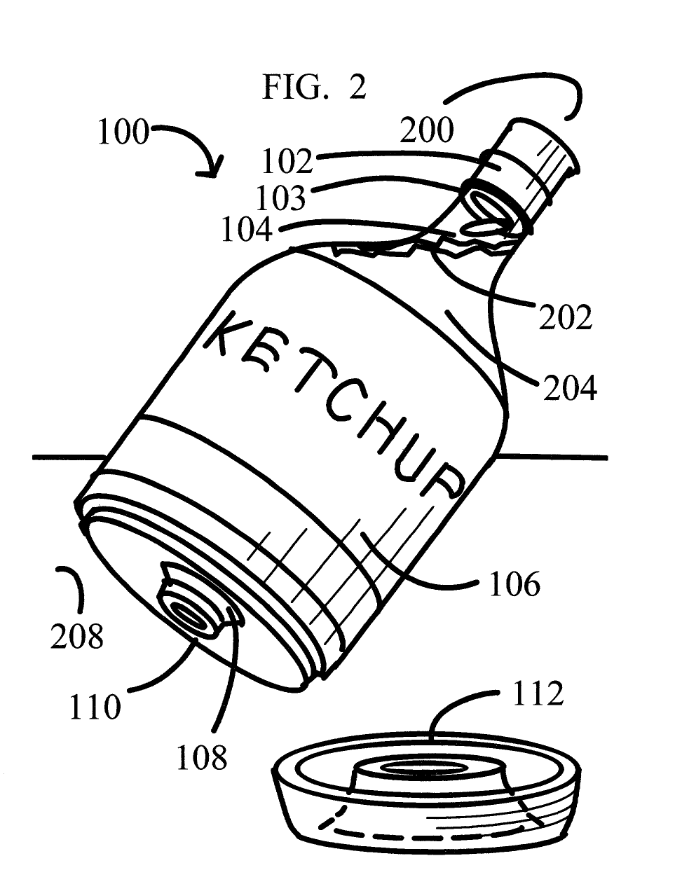

FIG. 2 is a close-up view of the actions of optionally twisting the Twist Ventilation Only Cap (102), and removing the False Bottle Bottom or Stand (112) to expose the Real Bottle Bottom with Nozzle (108). The Flip-off/Flip-on Nozzle Cap (110) on Real Nozzle Bottom with Nozzle (108) is shown in a closed position.

The actions of twisting the Twist Ventilation Only Cap (102) to prevent a vacuum on large dispenses is shown. The One-way Trap Door Diaphragm (103) is shown below the Twist Ventilation Only Cap (102) with the intended action of allowing air (200) intake in a downwards motion and preventing liquid dispensing from the Twist Ventilation Only Cap (102) and Real Bottle Top with Ventilation Hole (104) which prevents the unwanted effect of dried Liquid Chemical (204) blocking or partially blocking the dedicated top nozzle. The Flip-off/Flip-on Nozzle Cap (110) on Real Nozzle Bottom with Nozzle (108) is shown in a closed position. The Real Bottle Top with Ventilation Hole (104) and the Real Liquid Chemical Bottle Body (106) are shown. The action of removing the False Bottle Bottom or Stand (112) to expose the Real Bottle Bottom with Nozzle (108) is shown. The Flip-off/Flip-on Nozzle Cap (110) on Real Nozzle Bottom with Nozzle (108) is shown in a closed position.

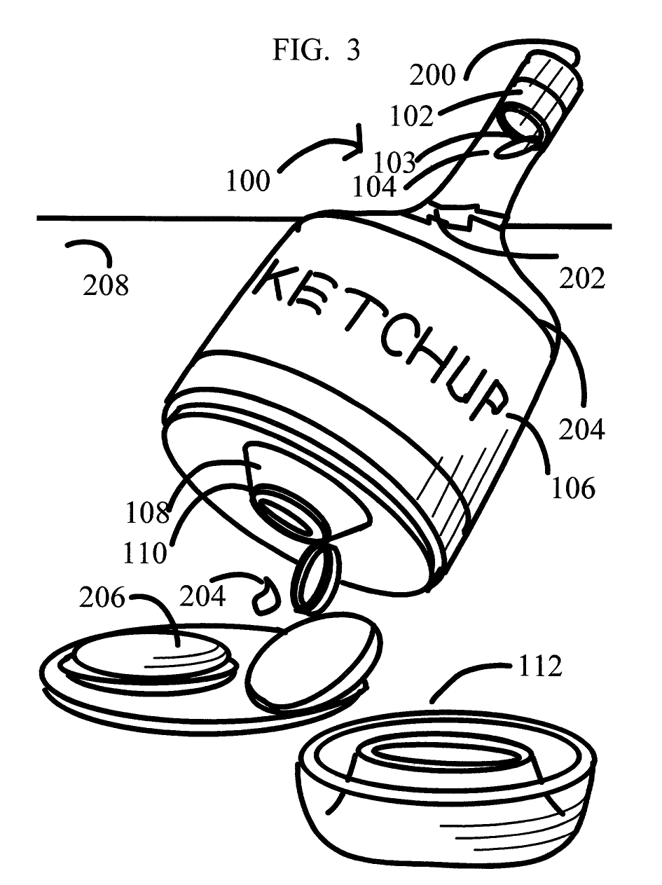

FIG. 3 is a close-up view of the action of dispensing Liquid Chemical (204) through the Real Bottle Bottom with Nozzle (108) after removal of the False Bottle Bottom or Stand (112) and opening the Flip-off/Flip-on Nozzle Cap (110) on Real Nozzle Bottom with Nozzle (108). A Hamburger (206) is shown to receive the Liquid Chemical (204) which in this case is ketchup.

The Twist Ventilation Only Cap (102) is shown already twisted open, the Real Bottle Top with Ventilation Hole (104) is shown letting in Air (200), the Liquid Chemical Bottle Body (106) is shown. The Non-Emulsified Liquid from Liquid Chemical (202) is shown settling to the top of the Liquid Chemical (204). The Liquid Chemical (204) is shown.

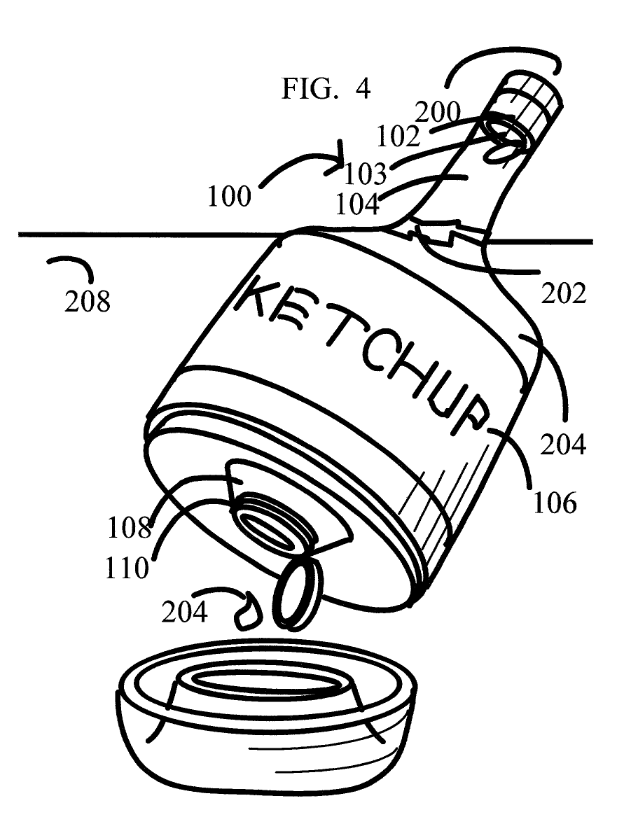

FIG. 4 is a close-up view of the action of closing the Flip-off/Flip-on Nozzle Cap (110) on Real Bottle Bottom with Nozzle (108), and placing the Liquid Chemical Bottle Body (106) back upon the False Bottle Bottom or Stand (112). The Twist Ventilation Only Cap (102) is lastly twisted shut.

The Real Bottle Top with Ventilation Hole (104) is shown. The Non-Emulsified Liquid from Liquid Chemical (202) is shown settling to the top of the Liquid Chemical (204).

### DESCRIPTION OF INVENTION

### Operation of Invention

Preferred Embodiment

FIG. 1 is a perspective drawing of the invention, a Gravity-fed Liquid Chemical Dispenser Bottle (100), as it would appear standing on a Kitchen Table (208).

The Twist Ventilation Only Cap (102) is shown, the One-way Trap Door Diaphragm (103) is shown, the Real Bottle Top with Ventilation Hole (104) is shown, the Liquid Chemical Bottle Body (106) is shown, the Real Bottle Bottom with Nozzle (108) is shown, and the False Bottle Bottom or Stand (112) is shown. The Non-Emulsified Liquid from Liquid Chemical (202) is shown settling to the top of the Liquid Chemical (204). The Liquid Chemical (204) is shown. The Gravity-fed Liquid Chemical Dispenser Bottle (100) may be optionally shaken before use.

FIG. 2 is a close-up view of the actions of optionally twisting the Twist Ventilation Only Cap (102), and removing the False Bottle Bottom or Stand (112) to expose the Real Bottle Bottom with Nozzle (108). The Flip-off/Flip-on Nozzle Cap (110) on Real Nozzle Bottom with Nozzle (108) is shown in a closed position.

The actions of twisting the Twist Ventilation Only Cap (102) to prevent a vacuum on large dispenses is shown. The Flip-off/Flip-on Nozzle Cap (110) on Real Nozzle Bottom with Nozzle (108) is shown in a closed position. The Real Bottle Top with Ventilation Hole (104) and the Real Liquid Chemical Bottle Body (106) are shown. The action of removing the False Bottle Bottom or Stand (112) to expose the Real Bottle Bottom with Nozzle (108) is shown. The Flip-off/Flip-on Nozzle Cap (110) on Real Bottle Bottom with Nozzle (108) is shown in a closed position.

FIG. 3 is a close-up view of the action of dispensing Liquid Chemical (204) through the Real Bottle Bottom with Nozzle (108) after removal of the False Bottle Bottom or Stand (112) and opening the Flip-off/Flip-on Nozzle Cap (110) on Real Nozzle Bottom with Nozzle (108). A Hamburger (206) is shown to receive the Liquid Chemical (204) which in this case is ketchup.

The Twist Ventilation Only Cap (102) is shown already twisted open, the Real Bottle Top with Ventilation Hole (104) is shown letting in Air (200), the Liquid Chemical Bottle Body (106) is shown. The Non-Emulsified Liquid from Liquid Chemical (204) is shown settling to the top of the Liquid Chemical (204). An optional action of squeezing the Liquid Chemical Bottle Body (106) will force the Liquid Chemical (204) out of the Real Bottle Bottom with Nozzle (108). The Liquid Chemical (204) is shown coming out the Real Bottle Bottom with Nozzle (108).

FIG. 4 is a close-up view of the action of closing the Flip-off/Flip-on Nozzle Cap (110) on Real Bottle Bottom with Nozzle (108), and placing the Liquid Chemical Bottle Body (106) back upon the False Bottle Bottom or Stand (112). The Twist Ventilation Only Cap (102) is lastly twisted shut.

The Real Bottle Top with Ventilation Hole (104) is shown. The Non-Emulsified Liquid from Liquid Chemical (202) is shown settling to the top of the Liquid Chemical (204).

### ADVANTAGES OF INVENTION

Preferred Embodiment

How the Objects are Achieved

A. An advantage of this invention is that it prevents the nagging wait for a prior art bottle turned upside-down to drain especially from a low bottle with thick condiments/pharmaceuticals.

This is due to the gravity-fed operation and bottom dispensing in the said invention.

B. An advantage of this invention is that it prevents the dispensing of air (200) and Non-emulsified Liquid from Liquid Chemical (202) which floats to the top of a prior art bottle.

This is due to the air (200) and Non-emulsified Liquid from Liquid Chemical (202) remaining on top while the dispensing is from the bottom in the said invention.

C. An advantage of this invention is that it stops the waste of Liquid Chemical (204) at the bottom of prior art bottles which is now often thrown away.

This is due to dispensing from the bottom in the said invention. Furthermore, prior art bottles required tipping the container over which deposited Liquid Chemical (204) from the previous bottom upon the gravity drained sides of the container.

D. An advantage of this invention is that it stops the waste of Liquid Chemical (204) at the sides of prior art bottles which clings there after the bottle is turned upside down and increases in side cling amount when the prior art bottle is near empty.

This is prevented by dispensing from the bottom of the said invention. Furthermore, prior art bottles required tipping the container over which deposited Liquid Chemical (204) from the previous bottom upon the gravity drained sides of the container.

E. An advantage of this invention is that it does not require the need to flip the prior art bottle upside down to dispense Liquid Chemical (204) such as in motor oil which creates messy spills and wastes effort when the target is missed.

This is prevented in the said invention by dispensing from the Real Bottle Bottom with Nozzle (108).

F. An advantage of this invention is that it is inexpensive and convenient to use in comparison to prior art bottles.

This is due to simple design and use of low cost materials in the said invention just as in prior art bottles.

G. An advantage of this invention is that it can be made with current manufacturing technologies for glass and plastic.

This is due to simple design in the said invention just as in prior art bottles.

H. An advantage of this invention is that it uses a dedicated Twist Ventilation Only Cap (102), Real Bottle Top with Ventilation Hole (104) for Air (200) ventilation and a dedicated to liquid, Real Bottle Bottom with Nozzle (108) for bottom only dispensing of the Liquid Chemical (204).

This allows “smooth and continuous” operation without “hiccuping actions” from a single nozzle for air (200) and liquid. This also prevents dried Liquid Chemical (204) from blocking or partially blocking the top Twist Ventilation Only Cap (102), One-way Trap Door Diaphragm (103), and Real Bottle Top with Ventilation Hole (104) if it is also used for Liquid Chemical (204) dispensing.

I. An advantage of this invention is that it uses a special One-way Trap Door Diaphragm (103) type of diaphragm at the top of the bottle to stop accidental Liquid Chemical (204) spills from the Real Bottle Top with Ventilation Hole (104) and Twist Ventilation Only Cap (102) and also to stop Liquid Chemical (204) dispensing from the top which will clog the air ventilation openings after drying.

This insures that the Twist Ventilation Only Cap (102) and Real Bottle Top with Ventilation Hole (104) is used only for air intake and not Liquid Chemical (204) dispensing preventing “gum up” and also accidental spills from the top if the bottle is flipped upside-down by mistake.

### ALTERNATIVE EMBODIMENTS

Description, Operation and Advantages of 1st Alternative Embodiment

Description of 1st Alternative Embodiment

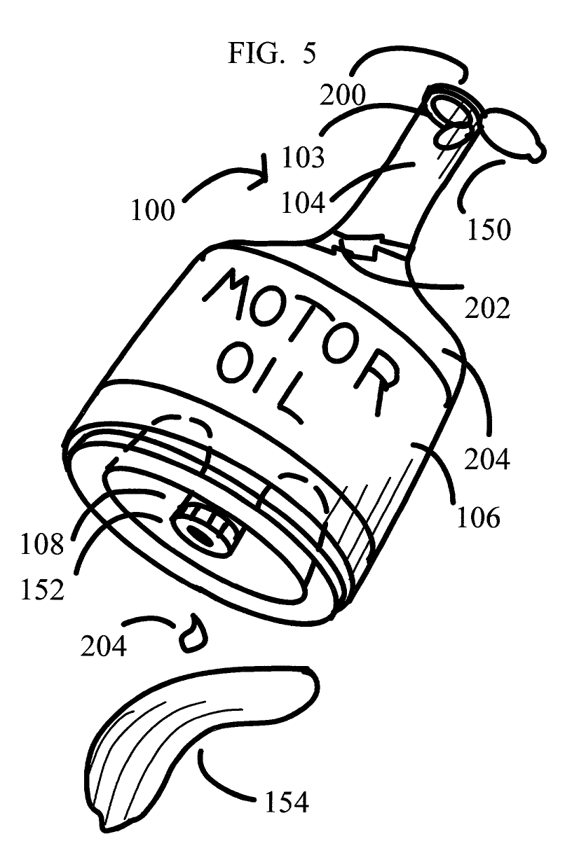

FIG. 5 is a standing view of an alternative embodiment, very low cost, Gravity-fed Liquid Chemical Dispenser Bottle (100) meant for disposable, 1-time dispensing use which uses a very low cost, 5-piece design:

1). A Top Self Adhesive Seal (150),

2). One-way Trap Door Diaphragm (103),

3). single piece bottle body consisting of a Real Bottle Top with Ventilation Hole (104), a Real Bottle Bottom with Nozzle (108) having a built-in, false bottle bottom or stand surrounding the Real Bottle Bottom with Nozzle (108) as shown,

4). a Twist Open Nozzle Cap (152) is placed upon the Real Bottle Bottom with Nozzle (108),

5). A Bottom Self-Adhesive Seal (154) is put on the Real Bottle Top with Ventilation Hole (104).

Removal of the Top Self-Adhesive Seal (150) and then Bottom Self-Adhesive Seal (154), and slowly twisting open the Twist-open Nozzle Cap (152) will dispense the contents in a controlled manner.

Operation of the 1st Alternative Embodiment

FIG. 5 is a standing view of an alternative embodiment, very low cost, Gravity-fed Liquid Chemical Dispenser Bottle (100) meant for disposable, 1-time dispensing use which uses a very low cost, 5-piece design:

1). A Top Self Adhesive Seal (150),

2). One-way Trap Door Diaphragm (103),

3). single piece bottle body consisting of a Real Bottle Top with Ventilation Hole (104), a Real Bottle Bottom with Nozzle (108) having a built-in, false bottle bottom or stand surrounding the Real Bottle Bottom with Nozzle (108) as shown,

4). a Twist Open Nozzle Cap (152) is placed upon the Real Bottle Bottom with Nozzle (108),

5). A Bottom Self-Adhesive Seal (154) is put on the Real Bottle Top with Ventilation Hole (104).

Removal of the Top Self-Adhesive Seal (150) and then Bottom Self-Adhesive Seal (154), and slowly twisting open the Twist-open Nozzle Cap (152) will dispense the contents in a controlled manner. The package is thrown away after dispensing.

Advantages of the 1st Alternative Embodiment

Are the same as for the preferred embodiment excepting that the cost of manufacture is especially low for one-time, dispensing use. Examples of use are for motor oil, packaged drinks, etc.

J. An advantage of this invention is that it uses a special One-way Trap Door Diaphragm (103) type of diaphragm at the top of the bottle (100) to stop accidental Liquid Chemical (204) spills from the Real Bottle Top with Ventilation Hole (104) and Twist Ventilation Only Cap (102).

### ALTERNATIVE EMBODIMENTS

Description, Operation and Advantages of 2nd Alternative Embodiment

Description of 2nd Alternative Embodiment

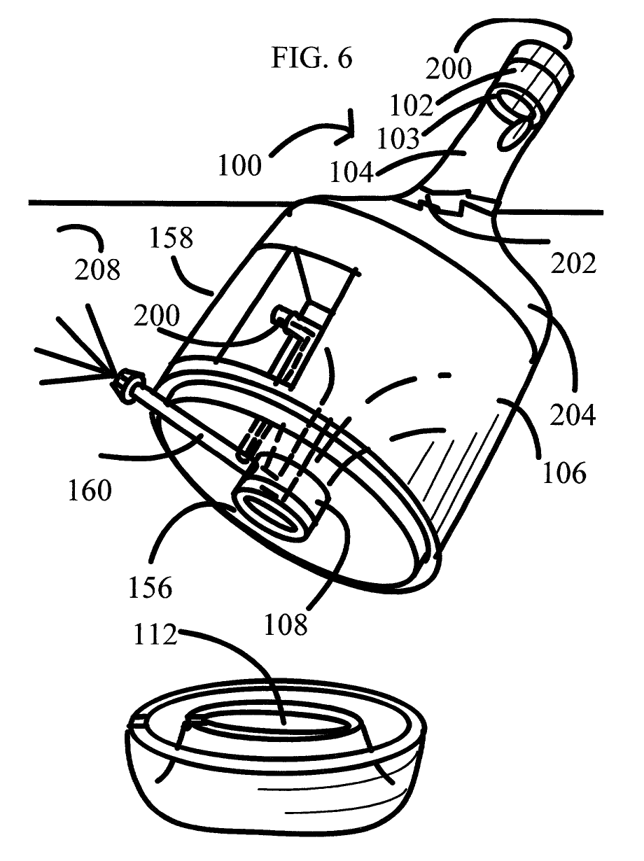

FIG. 6 is a standing view of an alternative embodiment, Gravity-Fed Liquid Chemical Dispenser Bottle (100) meant for a bottom dispensing, spray bottle with a Hand-Squeeze Pump Piston (158) mechanism.

Operation of 2nd Alternative Embodiment

FIG. 6 shows the Twist Open and Close Drip Deactivator (156) opened for spraying, the Adjustable Spray Pattern Nozzle (160) is set to the preferred spray pattern, and the Hand-Squeeze Pump Piston (158) is squeezed in and out to force air into the piston mechanism which will force a squirt of Liquid Chemical (204) out of the Adjustable Spray Pattern Nozzle (160).

Advantages of 2nd Alternative Embodiment

Same advantages as for preferred embodiment over prior art spray bottles. Also there is no Air (200) intake strokes when spraying at odd angles or when the Liquid Chemical (204) is very low exposing a prior art pump spray bottle's upward feed tube. There is no upwards feed tube in FIG. 6, just a Real Bottle Bottom with Nozzle (108).

K. An advantage of this invention used in an embodiment of a bottom-fed, bottom placed, hand-spray bottles which are upwards thumb depressed or sideways hand-squeezed into the bottle body (106). No frustrating “air (200) intake” strokes occur when a half-empty bottle is used slightly tipped to the side. In a prior art, top spray bottle with a suction tube, frustrating “air intake” (200) strokes occur and Liquid Chemical (204) is wasted with half empty bottles used slightly tipped to the side creating air (200) pockets around the base of the suction tube.

No suction tube is required and no air (200) pockets occur at slight, odd use angles with the said invention.

### DESCRIPTION OF INVENTION

Conclusion and Scope of Invention

A. This invention prevents the nagging wait for a prior art bottle turned upside-down to drain especially from the bottom of the bottle.

B. This invention prevents the dispensing of Air (200) and Non-emulsified Liquid from Liquid Chemical (202) which floats to the top of a prior art bottle.

C. This invention stops the waste of Liquid Chemical (204) at the bottom of prior art bottles which is now often thrown away.

D. This invention stops the waste of Liquid Chemical (204) at the sides of prior art bottles which clings there after the bottle is turned upside down and increases in amount when the bottle (100) is near empty.

E. This invention stops the need to flip the bottle (100) upside-down as for ketchup or motor oil which can result in messy spills when the target is missed.

F. This invention is inexpensive and convenient to use in comparison to prior art bottles.

G. This invention can be made with current manufacturing technologies for glass and plastic just like prior art bottles.

H. An object of this invention is that it uses a dedicated, Twist Ventilation Only Cap (102), and Real Bottle Top with Ventilation Hole (104) for Air (200) ventilation and a dedicated, Real Bottle Bottom with Nozzle (108) for bottom only dispensing of the Liquid Chemical (204). This effect is achieved by the One-way Trap Door Diaphragm (103) which prevents Liquid Chemical (204) dispensing from the top nozzle.

I. This invention uses a special One-way Trap Door Diaphragm (103) at the top of the bottle (100) to stop accidental Liquid Chemical (204) spills from the Real Bottle Top with Ventilation Hole (104) and Twist Ventilation Only Cap (102) and also to stop Liquid Chemical (204) dispensing from the top which will clog the air ventilation openings after drying.

J. This invention has an alternative embodiment of a very low cost, disposable bottle for one-time dispensing of things such as motor oil, anti-freeze, fuel-injector cleaner, oil treatments, gasoline treatments, brake fluid, transmission fluids, etc.

K. This invention has an alternative embodiment of a good bottom-fed, bottom placed, upwards thumb-depressed or sideways hand-squeezed action, hand-spray bottle (100) which is resistant to frustrating “air (200) intake” dispenses when used with a low bottle or at odd angles.

While my above description contains many specifications, these should not be construed as limitations on the legal claims of the invention, but rather as an example of one preferred embodiment thereof. Many other variations or secondary and alternative preferred embodiments are possible. For example a fully or partially removable False Twist Ventilation Only Cap (102) or fully attached Twist Ventilation Only Cap (102) can be optionally used. The bottle body (106) may be of any material including squeezable plastic, hard plastic, glass (will require a shaking motion, larger ventilation opening (104), and a larger dispensing nozzle), etc. The bottle (100) may be of any shape avoiding top-heavy design. The Flip-off/Flip-on Nozzle Cap 110) may be twist open and close, or flip open and close, or spray with a push-cap and feed. The False Bottle Bottom or Stand (112) can be screw-on for spill safety, flip-on, or snap on for convenience or a combination of both. The False Bottle Bottom or Stand (112) can be fully or partially detachable. Accordingly, the scope of the invention should be determined not by the embodiment(s) illustrated, but by the appended claims and their legal equivalents.

We claim:

1. A device for dispensing liquid chemicals comprising:
false cap,
one-way diaphragm mechanism,
real bottle top with ventilation,
liquid chemical bottle body,
real bottle bottom with nozzle,
nozzle cap,
removable stand,
with means for dispensing of the liquid chemicals utilizing gravity-fed operation through the nozzle on real bottom.

2. The invention of claim 1 further including that said false cap has mechanical means to open and close it in some manner to expose an air opening duct with means for preventing a bottle vacuum on dispensing large quantities of liquid chemical.

3. The invention of claim 2 further including that said false cap attaches to the real bottle top with ventilation using some sort of attachment device.

4. The invention of claim 1 further including that said one-way diaphragm mechanism has means to prevent liquid chemical from going upwards and means to allow air to penetrate downwards such as through use of a One-way Trapdoor Diaphragm or large pored diaphragm or diaphragm with a squeeze activated slit as example mechanisms.

5. The invention of claim 1 further including that said real bottle top with ventilation has means to stop a vacuum in the liquid chemical bottle body.

6. The invention of claim 5 further including that said real bottle top with ventilation is a real body top as opposed to the false cap.

7. The invention of claim 1 further including that said liquid chemical bottle body is of a non-top heavy shape to prevent tipping over of the bottle.

8. The invention of claim 1 further including that said liquid chemical bottle body has a real bottle bottom with nozzle as opposed to the stand or false bottle bottom.

9. The invention of claim 1 further including that said real bottle bottom with nozzle has a nozzle cap which has an openable and closable mechanical mechanism with means to dispense liquid chemical in a controlled manner.

10. The invention of claim 9 further including that said nozzle cap may be a bottom-fed, sideways hand-squeezed, pump-action spray nozzle which does not require a feed tube.

11. The invention of claim 1 further including that said stand or false bottom also catches liquid chemical drips.

12. The invention of claim 11 further including that said stand or false bottom attaches onto the Liquid Chemical real bottle bottom with nozzle and is detachable in some mechanical manner.

13. A device for dispensing liquid chemicals comprising:
false cap,
one-way diaphragm mechanism,
real bottle top with ventilation opening,
liquid chemical bottle body,
real bottle bottom with nozzle,
removable nozzle cap with stand,
with means for dispensing of the liquid chemicals utilizing gravity-fed operation through the nozzle on real bottom.

14. The invention of claim 13 further including that said false cap has mechanical means to expose an air opening duct through some user motion.

15. The invention of claim 14 further including that said false cap attaches onto the liquid chemical bottle body on the real bottle top with ventilation opening.

16. The invention of claim 14 further including that said false cap has an attachable mechanism of some type with means to allow air downwards, but, does not allow liquid to move up such as through use of a One-way Trapdoor Diaphragm or large pored diaphragm or diaphragm with a squeeze activated slit as example mechanisms.

17. The invention of claim 13 further including that said liquid chemical bottle body has a real bottle top with a ventilation opening as opposed to the false cap.

18. The invention of claim 13 further including that said liquid chemical bottle body is much narrower at the top than at the bottom to prevent top-heavy loading and tipping over of the bottle.

19. The invention of claim 13 further including that said liquid chemical bottle body has a real bottle bottom with a nozzle as opposed to the nozzle cap and stand or false bottle bottom.

20. The invention of claim 19 further including that said nozzle of real bottle bottom with nozzle has means to neatly dispense and aim liquid chemical when the nozzle cap and stand is removed.

21. The invention of claim 19 further including that said nozzle of real bottle bottom with nozzle can be a spray nozzle with a pump action mechanism of some kind with means to expel the liquid chemical under pressure such as in a sideways, hand-squeezed pump or in an upwards thumb-depressed pump.

22. The invention of claim 13 further including that said real bottle bottom with nozzle has an openable and closable nozzle cap and stand.

23. The invention of claim 22 further including that said nozzle of real bottle bottom with nozzle is covered by the nozzle cap with stand when the nozzle is not in use to protect it and stop drips.

24. The invention of claim 22 further including that said nozzle cap with stand of real bottle bottom mechanically attaches onto the liquid chemical bottle body through some attachment motion.

25. A device for dispensing liquid chemicals comprising:
disposable ventilation opening device such as adhesive foil,
one-way diaphragm mechanism,
liquid chemical bottle body with a ventilation opening, hollow stand, and nozzle,
openable cap for the nozzle,
disposable bottom anti-tamper seal such as adhesive foil,
with means for disposable, one-time dispensing use.

26. The invention of claim 25 further including that adhesive ventilation opening device has means to expose ventilation opening on the real bottle top.

27. The invention of claim 25 further including that liquid chemical bottle body with a ventilation opening, hollow stand, and nozzle has means to prevent a vacuum of liquid chemical.

28. The invention of claim 27 further including that liquid chemical bottle body with a ventilation opening, hollow stand, and nozzle has a one-way diaphragm which allows air downwards, but, does not allow liquid to move up through means of a mechanism such as a One-way Trapdoor Diaphragm or large pored diaphragm or diaphragm with a squeeze activated slit as example mechanisms.

29. The invention of claim 27 further including that liquid chemical bottle body with a ventilation opening, hollow stand, and nozzle is of a non top-heavy shape with means to prevent tipping over.

30. The invention of claim 27 further including that liquid chemical bottle body has a nozzle which may be a spray nozzle with pump action.

31. The invention of claim 27 further including that liquid chemical bottle body with a hollow stand may have a peel-off, disposable, tamper seal covering the base.

32. The invention of claim 25 further including that openable cap for the nozzle is opened with some mechanical action means with means to dispense liquid chemical in a controlled manner such as in a removable cap, twist cap, and flip cap.
